(19) United States
(12) Patent Application Publication
(10) Pub. No.: US 2017/0036583 A1
(43) Pub. Date: Feb. 9, 2017

(54) PLANAR STRUCTURE FROM A PLURALITY OF FOLDING PORTIONS

(71) Applicant: Ralf GROCHOWSKI, Rochester Hills, MI (US)

(72) Inventor: Ralf GROCHOWSKI, Rochester Hills, MI (US)

(21) Appl. No.: 15/229,907

(22) Filed: Aug. 5, 2016

Related U.S. Application Data
(60) Provisional application No. 62/202,343, filed on Aug. 7, 2015.

(51) Int. Cl. B60N 3/04

(52) U.S. Cl. CPC B60N 3/048; B60N 3/046

(57) ABSTRACT

Planar structure from a plurality of folding portions

A planar structure from a plurality of folding portions which are interconnected by way of integral hinges and which are erectable to a functional position so as to form a three-dimensional body, wherein fixing means are provided for mutually fixing the folding portions in the erected functional position, is known.

According to the invention, the folding portions are of triangular design in such a manner that the folding portions are erectable to form a supporting corner in the form of a triangular pyramid.

Employment in the cargo space of passenger motor vehicles.

### CROSS-REFERENCE TO RELATED APPLICATIONS

This claims priority from U.S. Provisional Application No. 62/202,343, filed Aug. 7, 2015, the disclosure of which is hereby incorporated by reference in its entirety into this application.

### FIELD OF THE INVENTION

The invention relates to a planar structure from a plurality of folding portions which are interconnected by way of integral hinges and which are erectable to a functional position so as to form a three-dimensional body.

### BACKGROUND OF THE INVENTION

A planar structure of this type in the form of a cover for a cargo-space floor is known from DE 198 10 714 A1. The cover has a water-tight integral planar structure. The planar structure is provided with flexible folding portions which have a central part and lateral parts which are disposed so as to be distributed around the central part. The lateral parts surrounding the central part may be erected to form an ashlar-shaped container. Respective fixing means serve for mutually fixing the lateral parts in the erected functional state. In a spread-out covering position all folding portions are disposed in one plane such that the flat planar structure thus designed may be used as a protective mat for a cargo-space floor.

### SUMMARY OF THE INVENTION

It is an object of the invention to achieve a planar structure of the type mentioned at the outset which enables a supporting function for cargo on a cargo-space floor of a motor vehicle.

This object is achieved in that the folding portions are of a triangular design in such a manner that the folding portions are erectable to form a supporting corner in the form of a triangular pyramid. The triangular pyramid herein is of open design such that the supporting corner can receive a corner region of a cargo such as of a carton, a box, or similar. The supporting corner has the effect of positionally securing a respective item to be transported in a cargo space. In a particularly advantageous manner, a plurality of planar structures according to the invention are provided so as to, by being erected in the functional position, form a plurality of supporting corners which in relation to the cargo tray may support items to be transported in the form of an ashlar, a box, or similar, on a plurality of sides. When not in use, the supporting corner may be spread out in a simple manner so as to form the planar structure such that said supporting corner may be accommodated in a space-saving manner on the cargo-space floor or on another point of the cargo space or of a vehicle interior of the motor vehicle. The supporting corner in the form of the open triangular pyramid represents an open tetrahedron.

In a design embodiment of the invention, the folding portions are at least partially provided with reinforcement plates. The reinforcement plates are preferably inserted between film regions of the folding portions and fixed between these film skins which are composed of plastics.

In a further design embodiment of the invention, a floor-side folding portion is provided with an anti-slip layer. The anti-slip layer may be configured in various forms. Said anti-slip layer may be formed by a rubber or elastomer layer of continuous or mutually spaced apart rubber or elastomer portions. Alternatively, said anti-slip layer may be formed by bonding means in the form of hook-and-pile elements, in the form of adhesive layers, or similar. It is essential for the anti-slip layer that a high level of static friction is achieved in relation to the surface of the cargo-space floor.

In a further design embodiment of the invention, bonding elements, in particular in the form of hook-and-pile elements, magnetic elements, adhesive elements, are provided. The bonding elements are capable of being manually converted to the fixing position or to the releasing position of the former.

Further advantages and features of the invention are derived from the claims and by means of the following description of preferred exemplary embodiments of the invention, which are illustrated by means of the drawings in which:

### BRIEF DESCRIPTION OF THE DRAWINGS

FIG. 1 schematically shows a cargo on a floor of a cargo space of a motor vehicle, said cargo being supported by four planar structures as per an embodiment according to the invention;

FIG. 2 in an enlarged perspective illustration shows a planar structure according to FIG. 1, which has been erected to form a piece corner;

FIG. 3 shows the planar structure as per FIG. 2 in a spread-out standby position;

FIGS. 4 to 6 show the planar structure as per FIGS. 2 and 3 in various positions during conversion from the standby position to the erected functional position;

FIG. 7 shows a further embodiment of a planar structure according to the invention, similar to that of FIG. 3;

FIG. 8 shows a further embodiment of a planar structure according to the invention;

FIGS. 9 to 12 show the planar structure as per FIG. 8 in various positions during conversion of the planar structure from the standby position to the erected functional position (FIG. 12);

FIG. 13 shows a further embodiment of a planar structure according to the invention, in a spread-out standby position;

FIGS. 14 and 15 show the planar structure as per FIG. 13, in various folded positions; and

FIG. 16 shows a further embodiment of a planar structure according to the invention, similar to that of FIG. 4, in a partially erected folded position.

### DETAILED DESCRIPTION

A cargo space L of a passenger motor vehicle has a cargo-space floor B which at mutually opposite sides is delimited by side walls. Toward the front, the cargo-space floor B is delimited in a manner not illustrated in more detail by a seatback assembly of a passenger cabin. Toward the rear, delimitation of the cargo-space floor B is performed by a rear end of the passenger motor vehicle, said rear end being potentially designed so as to be movable as a tailgate, or as to be static. Four supporting corners 1, each representing one planar structure in the context of the invention, are provided for positionally securing an in particular ashlar-shaped or box-shaped item to be transported T on the cargo-space floor B. The four supporting corners 1 are provided on four floor-side corner regions of the item to be transported T, wherein the supporting corners 1 are laterally pushed from the outside onto these corner regions until folding portions 2 to 4 (to be described in more detail hereunder) of the respective supporting corner 1 are in contact with the respective wall portions of the item to the transported T in these corner regions.

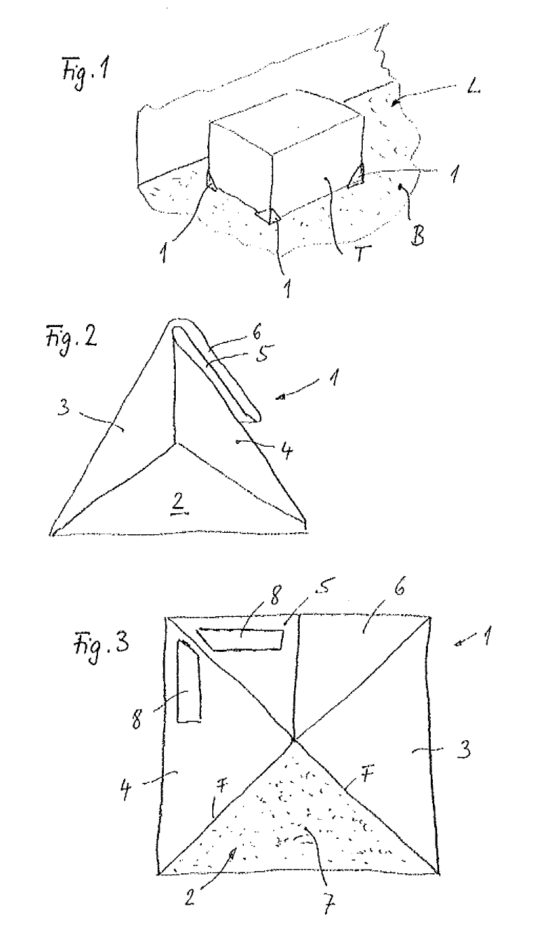

According to FIGS. 2 to 6, each supporting corner 1 is formed by a planar structure which in the spread-out standby position (FIG. 3) lies flat on a cargo-space floor B or on another support and which is of rectangular, presently square, design. The planar structure which forms the supporting corner 1 in FIG. 3 is viewed from a rear side. The planar structure has a first folding portion in the form of a base portion 2, and two further folding portions in the form of two lateral portions 3, 4. The lateral portions 3, 4, as well as the base portion 2, are in each case of triangular design. The lateral portions 3, 4, on mutually longitudinal sides of the base portion 2, are connected by a folding arrangement in the form of an integral hinge F to the base portion 2. Moreover, the planar structure has two folding portions 5, 6 which serve for fixing the supporting corner 1 in the erected functional position thereof according to FIGS. 2 and 6. The folding portions 5 and 6 are likewise of triangular design. The latter however only have half the area of the lateral portions 3, 4 and of the base portion 2. The two folding portions 5 and 6 are interconnected by a fold line. Moreover, according to FIG. 3, the latter are connected to the lateral portions 3, 4 by way of fold lines (not referred to in more detail) in the form of integral hinges.

As is indicated by means of FIG. 3, the base portion 2 in the region of the lower side thereof has an anti-slip layer 7 which in the exemplary embodiment illustrated is embodied as a rubber or elastomer layer. The lower side in the illustration as per FIG. 3 lies on top.

Moreover, according to FIGS. 1 to 6, the planar structure which is erectable to form the supporting corner 1 in the region of the one folding portion 5 and in the region of the lateral portion 4 is provided with fixing means 8 which in the exemplary embodiment illustrated are designed as hook-and-pile elements.

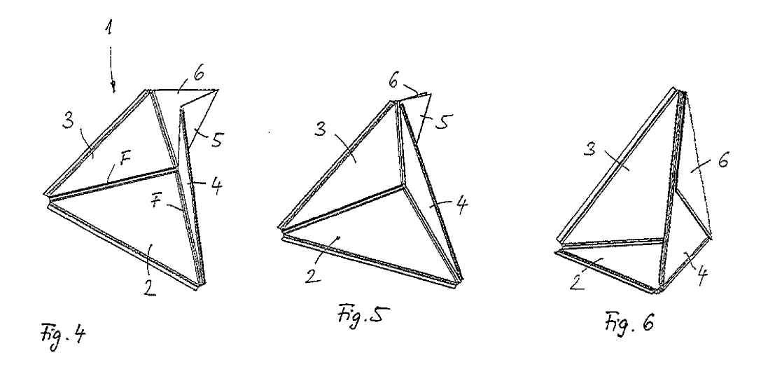

According to FIGS. 2 and 6, erecting the planar structure to form the supporting corner 1 is performed according to the illustrations as per FIGS. 4 and 5. The two lateral portions 3, 4 are first erected in relation to the base portion 2. Herein, the two folding portions 4, 6 are folded outward toward the rear side and are folded on top of one another. Herein, the hook-and-pile element of the folding portion 5 is brought to a position which is directly adjacent to the hook-and-pile element which is disposed on the outside on the lateral portion 4, such that the folding portions 5 and 6 which are folded together to form the overlapping triangle are fixed on the outside to the lateral portion 4. On account thereof, the erected functional position of the supporting corner 1 is achieved and secured.

The base portion 2 as well as the lateral portions 3 and 4 are provided with reinforcement plates which are integrated in the respective folding portions. Preferably, the folding portions 2 to 4 are formed by plastics films which each represent one external skin and one internal skin. The respective reinforcement plate is inserted between the external skin and the internal skin. The external skin and the internal skin are welded to one another at the peripheral regions of the reinforcement plate. The reinforcement plates are of triangular design, in an analogous manner to the folding portions 2 to 4. No reinforcement plates are provided in the region of the integral hinges F, so as not to impede the flexibility of the integral hinges F. The integral hinges are formed by external and internal skins of the plastics films in that the external and internal skin are welded to one another in this region.

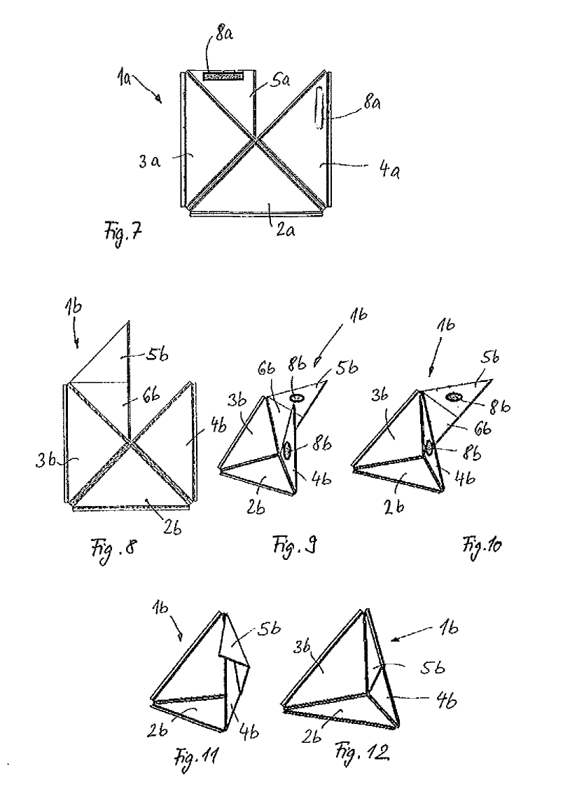

The embodiments as per FIGS. 7 to 16 correspond substantially to the embodiment which has been described above by means of FIGS. 1 to 6. Therefore, parts and portions having equivalent functions are provided with the same reference signs having index letters a or b, respectively, or c and d, respectively. The supporting corners 1a, 1b, 1c, and 1d, according to FIGS. 7 to 16, are also provided for positioning on a cargo-space floor B, in an analogous manner to FIG. 1. The folding portions 2a to 4a, and 2b to 4b, and 2c to 4c, and 2d to 4d, are provided with triangular reinforcement plates in the same manner as is the case with the embodiment as per FIGS. 1 to 6. The integral hinges F or fold lines, respectively, are embodied in an identical manner. The points of difference of the embodiments according to FIGS. 7 to 16 will be discussed hereunder.

It is a substantial point of difference in the case of the supporting corner 1a as per FIG. 7, that the planar structure indeed has a base portion 2a and two lateral portions 3a, 4a, which are configured in a substantially identical manner to the folding portions in the case of the embodiment according to FIGS. 1 to 6. However, the planar structure has only one single further folding portion 5a which is articulated only on the one lateral portion 3a by way of a respective integral hinge. The lateral portion 4a on the external side has a fixing means 8a which is designed as a hook-and-pile element. The folding portion 5a on the internal side has a complementary hook-and-pile element as a fixing means 8a. Once the lateral portions 3a, 4a are folded up, the folding portion 5a is pressed from the outside onto the lateral portion 4a, on account of which the fixing means 8a are brought into mutual contact, securing the erected functional position.

The supporting corner 1b as per FIGS. 8 to 12 also corresponds substantially to the embodiments which have been described above. It is a substantial point of difference in the case of the supporting corner 1b that the planar structure beside the base portion 2b and the two lateral portions 3b and 4b has two folding portions 5b, 6b, of which only the one folding portion 6b is connected directly to the lateral portion 3b. By contrast, the other folding portion 5b is connected only to the folding portion 6b. The folding portions 5b and 6b, in a manner analogous to the folding portions 5, 6, and to the folding portion 5a, are provided with dimensions which are halved in relation to the lateral portions 3b, 3b.

In the case of the supporting corner lb the lateral portion 4b on the internal side is provided with a fixing means 8b in the form of a hook-and-pile element. The folding portion 5b is provided with a complementary fixing means 8b in the form of a corresponding hook-and-pile element. During erection of the two lateral portions 3b, 4b the folding portion 6b at the rear side is folded onto the external side of the lateral portion 4b, wherein a fold line between the two folding portions 5b, 6b is axiomatically aligned so as to be flush with an upper edge of the lateral portion 4b. Subsequently, according to FIGS. 11 and 12, the folding portion 5b may be folded over from above toward the internal side of the lateral portion 4b, on account of which the fixing means 8b come into mutual contact. On account thereof, the erected functional position of the supporting corner 1b is achieved and secured.

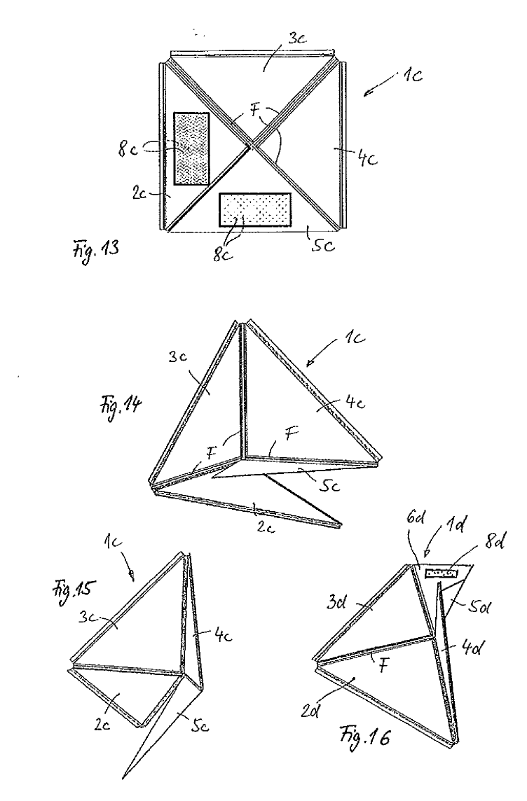

In the case of the supporting corner 1c as per FIGS. 13 to 15, a total of four folding regions which are embodied as the base portion 2c, as the lateral portions 3c, 4c, and as the folding portion 5c, are provided. The base portion 2c and the first lateral portion 3c are interconnected by way of a fold line in the form of an integral hinge F. The two lateral portions 3c and 4c are also interconnected by way of an integral hinge f. The folding portion 5c by way of a further folding line in the form of an integral hinge F is connected to a lateral periphery of the lateral portion 4c. However, this folding portion 5c by way of a slot is separated from the base portion 2c, the latter in the spread-out standby position according to FIG. 13 is adjacent to the left of the former. Both the base portion 2c as well as the folding portion 5c have fixing means 8c each on the upper side and on the lower side. Alternatively, it is possible for fixing means 8c to be provided only on an upper side or lower side in the case of each the base portion 2c and in the case of the folding portion 5c, said fixing means 8c then having to be disposed such that, depending on the folding strategy, they come into mutual contact. Therefore, when the folding portion 5c is applied to the upper side of the base portion 2c, the lower side of the folding portion 5c, and the upper side of the base portion 2c, each have to be provided with one fixing means 8c. Conversely, if the folding portion 5c is to be fixed to the base portion 2c from below (FIG. 15), then the folding portion 5c in the region of the upper side, and the base portion 2c in the region of the lower side, are provided with a respective fixing means 8c.

In the embodiment illustrated, in the case of which fixing means 8c are provided on both sides, an operator may perform folding according to FIG. 14 or alternatively folding according to FIG. 15. Secure fixing of the folding portion 5c in relation to the base portion 2c is achievable in both cases.

The supporting corner 1d according to FIG. 16 corresponds substantially to the supporting corner 1 as per FIG. 4. The only point of differentiation is that in the case of the supporting corner ld the folding portion 6d on the internal side is provided with a fixing means 8d, whereas the folding portion 5d has no fixing means. The lateral portion 4d on the external side is provided with a complementary fixing means which is not illustrated by means of FIG. 16. The folding portion 5d is cut out such that the folding portion 6d, which during folding is on the external side, may come into direct contact with the external-side fixing means of the lateral portion 4d. On account thereof, simplified and more compact fixing of the supporting corner 1d than in the case of the embodiment according to FIG. 4 is achievable.

Since the fixing means 8, 8a, 8b, 8c, 8d in the case of all embodiments are embodied so as to be releasable, the supporting corners 1, 1a, 1b, 1c, 1d may be converted in the same manner from the erected functional position thereof back to the spread-out standby position thereof in which said supporting corners 1, 1a, 1b, 1c, 1d result in the flat planar structures according to FIGS. 3, 7, 8, and 13.

1. Planar structure from a plurality of folding portions which are interconnected by way of integral hinges and which are erectable to a functional position so as to form a three-dimensional body, wherein fixing means are provided for mutually fixing the folding portions in the erected functional position, wherein the folding portions are of triangular design in such a manner that the folding portions are erectable to form a supporting corner in the form of a triangular pyramid.

2. Planar structure according to claim 1, wherein the folding portions are at least partially provided with reinforcement plates.

3. Planar structure according to claim 1, wherein a floor-side folding portion is provided with an anti-slip layer.

4. Planar structure according to claim 1, wherein bonding elements, in particular in the form of hook-and-pile elements, magnetic elements, adhesive elements, are provided as fixing means.
